(19) United States
(12) Patent Application Publication
(10) Pub. No.: US 2015/0178679 A1
(43) Pub. Date: Jun. 25, 2015

(54) Customer Management System and Customer Management Method

(71) Applicant: NIPPON GAS CO., LTD., Tokyo (JP)

(72) Inventors: Shinji Wada, Tokyo (JP); Shingo Dekamo, Tokyo (JP)

(21) Appl. No.: 14/412,995

(22) PCT Filed: Jul. 4, 2013
(86) PCT No.: PCT/JP2013/004164

§ 371 Date: Jan. 5, 2015

(30) Foreign Application Priority Data
Jul. 6, 2012 (JP) 2012-152637

(51) Int. Cl. G06Q 10/08; G06F 17/30; G06Q 50/06

(52) U.S. Cl. CPC G06Q 10/0838; G06Q 50/06; G06F 17/30345

(57) ABSTRACT

The present invention is a customer management system wherein a delivery server includes a storage device that manages a list that includes multiple customer data targeted for meter reading, and a receiver that receives cancellation data for a customer's gas contract. Moreover, the delivery server includes an update unit that, based on the cancellation data, deletes data for a cancelled customer from the multiple customer data included in the list to update the list. Furthermore, the delivery server includes a transmitter that transmits the updated list to communication terminals.

### TECHNICAL FIELD

The present invention relates to a system and method for managing customer data.

### BACKGROUND ART

LP gas is known to be supplied by gas imported from industrial gas producing countries, and gas domestically generated as a secondary product when petrochemical products are produced. Import stations that store the LP gas transported by tankers from the industrial gas producing countries and oil refinery stations are called primary terminals. The LP gas in the primary terminals is loaded into coastal vessels and tank trucks, and shipped to secondary terminals, which are transit stations located along or away from the coasts. Further, the LP gas carried to the secondary terminals is transported to LP gas filling stations in various places, which are delivery bases, and is employed to fill gas cylinders in the delivery bases.

The gas cylinders filled with the LP gas in the filling stations are delivered by deliverymen to customers' homes, such as general homes, apartment buildings and offices. The empty gas cylinders at the customers' houses are replaced with filled gas cylinders, and the empty gas cylinders are collected at the filling stations. The individual filling stations have fixed delivery areas to be assigned for deliverymen. Delivery slips for two to ten days, indicating the houses of customers in the delivery areas to deliver the gas cylinders, are handed over to the deliverymen.

The delivery slip is prepared by a delivery manager. First, for each customer, the remaining amount of the LP gas in the gas cylinder is predicted based on the gas usage history, the indication of a gas meter (hereinafter “meter indication”) installed at the customer's home, a delivery history, etc., and the next delivery due date for a gas cylinder is determined. The remaining amounts of the LP gas in the gas cylinders, thus predicted for all of the customers in the delivery areas allocated to the deliverymen, are added together to determine the amount of delivery of gas cylinders for two to ten days.

When the deliveryman has exchanged the gas cylinders in accordance with the delivery slip, he or she enters, to the delivery slip, the date of replacement, the meter indication on the date of replacement, the cylinder number and the individual safety inspection items. At the end of the daily delivery operation, the delivery slip is submitted to the delivery manager. The delivery manager examines the delivery slip thus returned to the delivery manager to determine whether there are omissions in entry, and thereafter, stores the slip as data used to calculate the next delivery due date. For such a system, various methods for increasing the efficiency for delivery of gas cylinders have been proposed (see patent literature 1).

As disclosed in Patent Literature 1, there has been a conventional system that is able to improve the efficiency of deliveries of gas cylinders, and when there was a cancellation of a gas contract, it took a long time to delete that customer data from among multiple customer data targeted for meter reading of a gas meter to be reflected in the system. Therefore, there was a possibility that the gas meter of the cancelled customer would be read.

### CITATION LIST

### Patent Literature

PTL1: Japanese Patent Laid-Open No. 08-329159(1996)

### SUMMARY OF INVENTION

### Technical Problem

In consideration of the condition described above, the object of the present invention is to provide a customer management system and customer management method that is able to obtain a list of customers targeted for meter reading by more quickly reflecting the cancellation status of gas contracts.

### Solution to Problem

In order to solve the problem above, the present invention is a customer management system, that includes: a management unit that manages a list that includes multiple customer data targeted for meter reading; a receiver that receives cancellation data for a customer's gas contract; an update unit that, based on the cancellation data, deletes data for a cancelled customer from the multiple customer data included in the list to update the list; and a transmitter that transmits the updated list to a communication terminal.

Moreover, in order to solve the problem above, the present invention is a customer management method by a computer for deleting data for a cancelled customer from a list that includes multiple customer data targeted for meter reading, wherein the computer comprises a management unit that manages the list; and the method includes: receiving cancellation data for a customer's gas contract; deleting data for a cancelled customer from the multiple customer data included in the list to update the list based on the cancellation data; and transmitting the updated list to a communication terminal.

### Advantageous Effects of Invention

With the present invention, it is possible obtain a list of customers targeted for meter reading by more quickly reflecting cancellation status of gas contracts.

### BRIEF DESCRIPTION OF DRAWINGS

FIG. 1 is a drawing illustrating an example of network configuration of an embodiment of the present invention;

FIG. 2 is a block diagram illustrating an example of a configuration of the delivery server in FIG. 1;

FIG. 3 is a flowchart illustrating an example of the overall operation of a delivery server of an embodiment of the present invention;

FIG. 4 is a drawing of an embodiment of the present invention, and illustrates an example of a list that includes multiple customer data targeted for meter reading; and

FIG. 5 is a drawing of an embodiment of the present invention, and illustrates an example of an operation screen on a mobile terminal to which an updated list has been transmitted.

### DESCRIPTION OF EMBODIMENTS

In the following, a summary of a configuration of a system of an embodiment will be explained. This system, for example, is based on cancellation data for a customer's gas contract obtained from a mobile terminal, for example, deletes data for a cancelled customer from a list that includes multiple customer data targeted for meter reading.

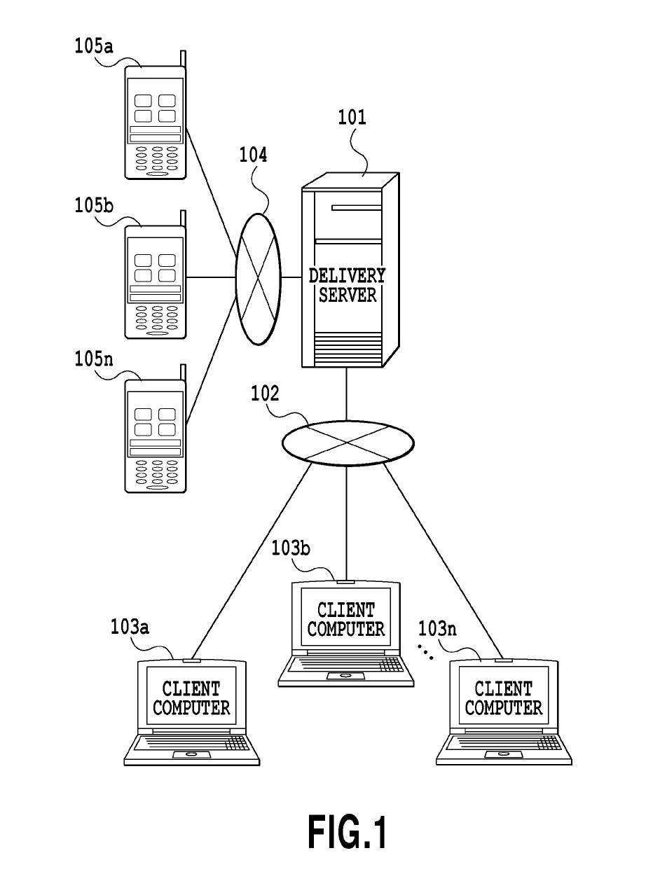

FIG. 1 is a drawing that illustrates the network configuration of an embodiment of the present invention. In FIG. 1, a delivery server (customer management system) 101 is configured to be able to communicate with multiple client computers 103a, 103b, . . . , 103n via a network 102. Furthermore, this delivery server 101 is configured to be able to communicate with a plurality of mobile terminals (communication terminals) 105a, 105b, . . . , 105n. In a common explanation for each of the multiple client computers 103a to 103n, each client computer will be referred to as simply client computer 103, and in a common explanation for each of the mobile terminals 105a to 105n, each mobile terminal will be referred to as simply mobile terminal 105.

A client computer 101 is a terminal that is located at a delivery center that centrally manages deliveries at each delivery base, and is used by a user at the delivery center. The user connects to the delivery server 101 via the client computer 103 to perform work specific to delivery services, such as checking delivery status and transmitting a delivery data creation instruction. The installation location of the client computer 103 can also be at a delivery base, for example.

A mobile terminal 105 is used by a worker (for example, this includes a meter reader, a deliveryman, a safety inspector and the like) that checks the meter reading of a gas meter that is attached to a supply facility that comprises a gas cylinder, and comprises a CPU, memory, input device and display device. The worker, byway of the mobile terminal 105, collects meter indication data that includes the meter reading of a gas meter, and transmits that data to a delivery server 101. The meter indication data is transmitted to the delivery server 101, for example, when reading a meter, when opening or closing a gas cock, when performing a safety inspection, when delivering a gas cylinder, when replacing a gas meter and the like.

### [Configuration of a Delivery Server]

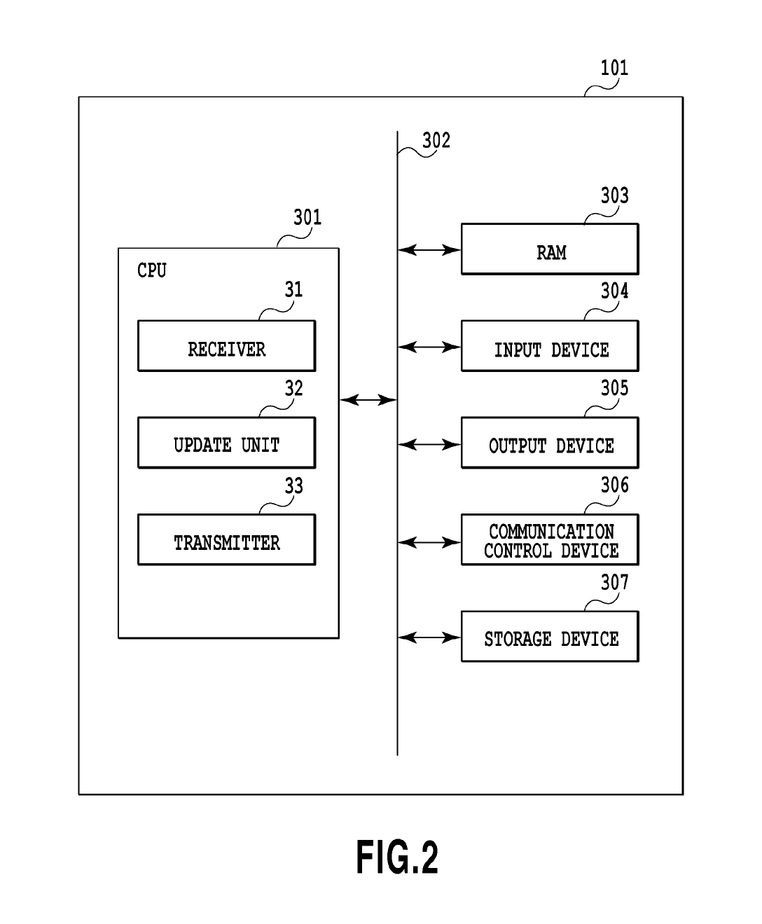

FIG. 2 is a block diagram illustrating an example of a configuration of a delivery server 101. In FIG. 2, a case in which a single computer system is employed is explained, however the delivery server 101 may also be configured as part of a multi-functional distributed system made up of multiple computer systems.

As illustrated in FIG. 2, the delivery server 101 has a CPU 301, a system bus 302, RAM 303, an input device 304, an output device 305, a communication control device 306 and a storage device (management unit) 307.

The CPU 301 is connected to all of the components via the system bus 302, and together with performing processing for transferring control signals and data, executes various software programs for achieving the overall operation of the delivery server 101, performs arithmetic processing and the like.

The RAM 303 is provided with a work area for temporarily storing data and software programs.

The storage device 307 comprises a non-volatile storage medium such as ROM, HDD or the like, and comprises a program storage area that stores software programs, and a data storage area that stores data obtained as needed and data as a result of processing. For example, by reading a software program from the program storage area of the storage device 307 into the work area of the RAM 303, and executing that software program by the CPU 301, the CPU 301 of this embodiment achieves functions of the units 31 to 33 that will be described later.

The CPU 301, as illustrated in FIG. 2, comprises a receiver 31, an update unit 32 and a transmitter 33.

The receiver 31 receives cancellation data for a customer's gas contract.

The update unit 32, based on the cancellation data, deletes the data for a cancelled customer from among the multiple customer data included in the list targeted for meter reading to update the list.

The transmitter 33 transmits the updated list to the mobile terminals 105.

### [Operation of a Delivery Server]

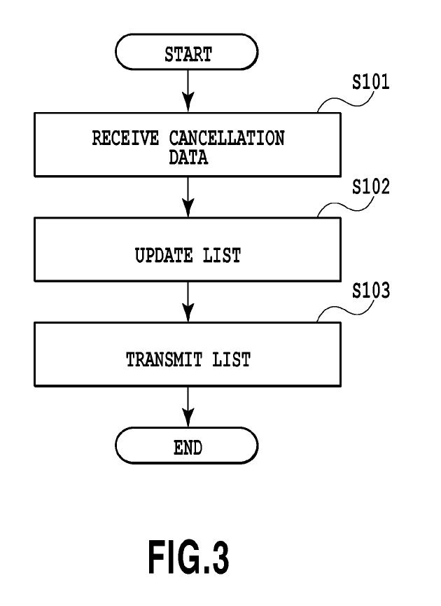

FIG. 3 is a flowchart illustrating an example of the overall operation of a delivery server 101.

For example, a mobile terminal 105 transmits cancellation data that indicates a cancellation when a customer cancels a gas contract to the delivery server 101, and the CPU 301 (receiver 31) of the delivery server 101 receives the cancellation data (S101).

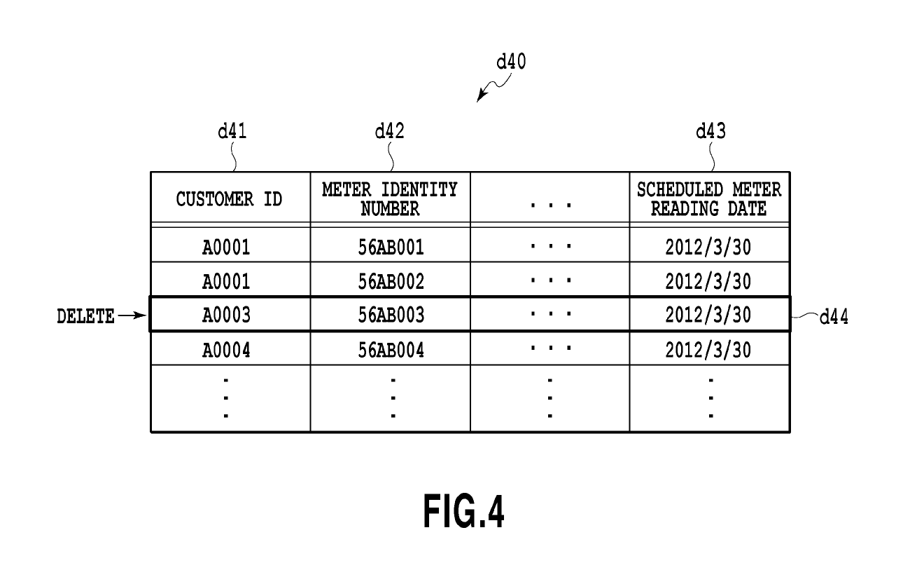

The cancellation data includes the “customer ID”, the “meter identity number” and the “cancellation date”. The CPU 301 (update unit 32) of the delivery server 101 compares this cancellation data with the multiple customer data targeted for meter reading that are in the list stored in the storage device 307, and as a result of the comparison, deletes the data for matching customer from the list to update the list (S102). FIG. 4 illustrates an example of this list. FIG. 4 is a figure for explaining an example of a list. The list d40 that is illustrated in FIG. 4 includes the “customer ID” d41, the “meter identity number” d42 and the “scheduled meter reading date” mentioned above, and is stored in the storage device 307. In step S102, the update unit 32 determines the customer having customer ID “A0003” is matching as the result of the above comparison, and deletes the record related to that customer (indicated by the bold frame d44 in FIG. 4).

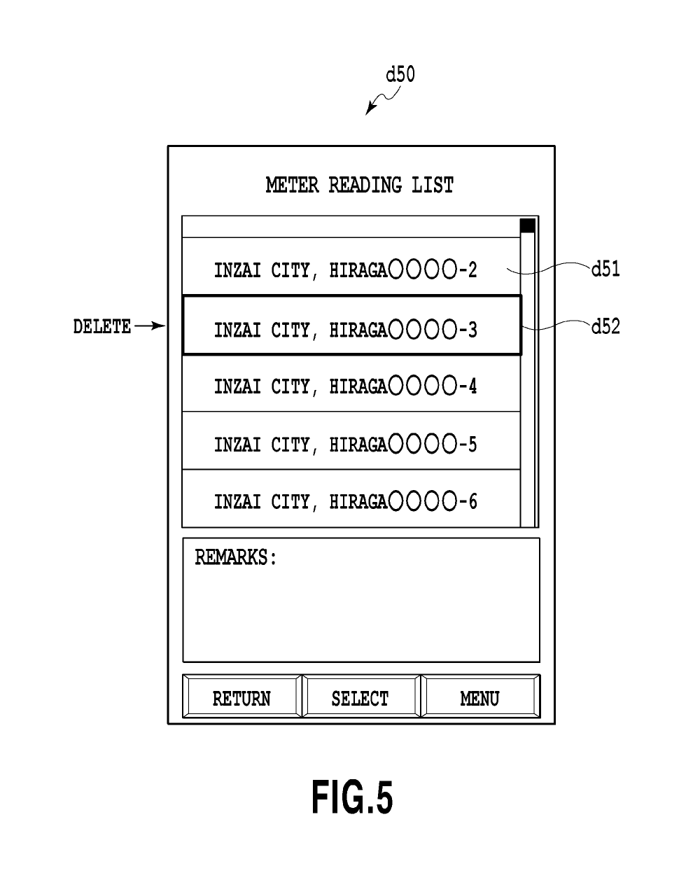

Then the CPU 301 (transmitter 33) of the delivery server 101 transmits the updated list described above to the mobile terminal 105 (S103). The mobile terminal 105 is used by a meter reader, and the meter reader can confirm this list. The list that a meter reader confirms on a mobile terminal 105 is displayed on a display screen such as illustrated in FIG. 5. FIG. 5 is a figure illustrating an example of a display screen d50 of a mobile terminal 105 after an updated list has been transmitted. In the list d51 that is illustrated in FIG. 5, the addresses of customers targeted for meter reading are arranged and displayed. Here, for example, when the customer whose address is “Inzai City, Hiraga [symbol] -3” has cancelled, the above update unit 32 updates the list based on the cancellation data, and transmits the updated list to the mobile terminal 105. After that, the transmitted list is reflected on the display screen of the mobile terminal 105, and the data on the display screen of the cancelled customer whose address is “Inzai City, Hiraga [symbol] -3” is to be deleted (indicated by the bold frame d52 in FIG. 5). Because meter reading is performed by viewing the data for only contracted customers, and meter reading is not performed for customers that have cancelled. In this way it is possible to obtain a list of customers targeted for meter reading by more quickly reflecting the cancellation status of gas contracts.

In step S101, transmission of the cancellation data can also be performed by a client computer 103 instead of a mobile terminal 105.

All of the meter indication data described above is stored in the storage device 307, and during processing in step S103, corresponding meter indication data is read from the storage device 307.

As was explained above, when a customer cancels a gas contract, the delivery server 101 of this embodiment manages a list that includes multiple customer data targeted for meter reading, and receives cancellation data for the customer's gas contract. The delivery server 101, based on the received cancellation data, deletes the data for the cancelled customer from the multiple customer data included in the list, and updates the list, then transmits the updated list to the mobile terminal 105. Therefore, it is possible to obtain a list of customers targeted for meter reading by more quickly reflecting the cancellation status of gas contracts.

An embodiment was explained above, however, the specific data structure is not limited by the embodiment, and can be changed.

1. A customer management system that comprises a server and a communication terminal, wherein
the server includes:
a management unit that manages a first list that includes multiple customer data that includes a first customer ID and a monthly scheduled meter reading date;
a receiver that, during a meter reading period that includes the monthly scheduled meter reading date, receives cancellation data from a client that includes a second customer ID and cancellation date that a gas contract is cancelled, the cancellation data related to a gas contract that is cancelled on the cancellation date;
an update unit that, when the second customer ID included in the received cancellation data matches the first customer ID included in the customer data that is included in the first list, deletes the customer data related to the matching first customer ID from the first list to update the first list; and
a transmitter that transmits the updated first list to a communication terminal;
the communication terminal includes unit for
managing a meter reading list that lists customer data targeted for meter reading on the scheduled meter reading date,
receiving the updated first list,
deleting customer data targeted for cancellation from the meter reading list based on the received updated first list, and
displaying the meter reading list after deletion on the display screen of the communication terminal during the meter reading period; and wherein
a series of processing that includes the processing by the updating unit and transmitter of the server, and the processing by the unit of the communication terminal is performed every time that the receiver receives the cancellation data; and
by deleting customer data targeted for cancellation from the meter reading list, a customer targeted for cancellation is removed from target for meter reading on the scheduled meter reading date during the meter reading period.

2. A customer management method by a customer management system that comprises a server and communication terminal, wherein
the server comprises a management unit that manages a first list that includes multiple customer data that includes a first customer ID and a monthly scheduled meter reading date; and the method by the server includes:
receiving cancellation data from a client that includes a second customer ID and cancellation date that a gas contract is cancelled during a meter reading period that includes the monthly scheduled meter reading date, the cancellation data being related to a gas contract that is cancelled on the cancellation date;
when the second customer ID included in the received cancellation data matches the first customer ID included in the customer data that is included in the first list, deleting customer data related to the matching first customer ID from the first list to update the first; and
transmitting the updated first list to a communication terminal; and
the method by the communication terminal includes:
managing a meter reading list that lists customer data targeted for meter reading on the scheduled meter reading date,
receiving the updated first list,
deleting customer data targeted for cancellation from the meter reading list based on the received updated first list, and
displaying the meter reading list after deletion on the display screen of the communication terminal during the meter reading period; and wherein
a series of processing that includes the processing of the updating step and transmitting step of the server, and the processing of the display step of the communication terminal is performed every time that receives the cancellation data at the receiving step; and
by deleting customer data targeted for cancellation from the meter reading list, a customer targeted for cancellation is removed from target for meter reading on the scheduled meter reading date during the meter reading period.

3. A computer-readable storage medium having computer-executable instructions which cause a customer management system that comprises a server and communication terminal to perform a customer management method, wherein
the server comprises a management unit that manages a first list that includes multiple customer data that includes a first customer ID and a monthly scheduled meter reading date; and the method by the server includes:
receiving cancellation data from a client that includes a second customer ID and cancellation date that a gas contract is cancelled during a meter reading period that includes the monthly scheduled meter reading date, the cancellation data being related to a gas contract that is cancelled on the cancellation date;
when the second customer ID included in the received cancellation data matches the first customer ID included in the customer data that is included in the first list, deleting customer data related to the matching first customer ID from the first list to update the first list; and
transmitting the updated first list to a communication terminal; and
the method by the communication terminal includes:
managing a meter reading list that lists customer data targeted for meter reading on the scheduled meter reading date,
receiving the updated first list,
deleting customer data targeted for cancellation from the meter reading list based on the received updated first list, and
displaying the meter reading list after deletion on the display screen of the communication terminal during the meter reading period; and wherein
a series of processing that includes the processing of the updating step and transmitting step of the server, and the processing of the display step of the communication terminal is performed every time that receives the cancellation data at the receiving step; and
by deleting customer data targeted for cancellation from the meter reading list, a customer targeted for cancellation is removed from target for meter reading on the scheduled meter reading date during the meter reading period.
